(19) United States
(12) Patent Application Publication
(10) Pub. No.: US 2005/0102811 A1
(43) Pub. Date: May 19, 2005

(54) Method of assembling an appliance with interchangeable consoles

(75) Inventors: Jordan S. Bruntz, Baxter, IA (US); Michael R. Campbell, Johnston, IA (US); Richard R. Dix, Newton, IA (US); Donald E. Erickson, Newton, IA (US); Charles L. Jackson, Newton, IA (US); Julie A. Kluin, Altoona, IA (US); Richard J. Mally, Newton, IA (US); Phil E. Stepp, Kellogg, IA (US)

Correspondence Address: MCKEE, VOORHEES & SEASE, P.L.C.;ATTN: MAYTAG, 801 GRAND AVENUE, SUITE 3200, DES MOINES, IA, 50309-2721, US

(73) Assignee: Maytag Corporation, Newton, IA (US)

(21) Appl. No.: 10/713,370

(22) Filed: Nov. 14, 2003

(51) Int. Cl. B23P 17/04; B21K 21/16; D06F 33/00

(52) U.S. Cl. 29/401.1; 29/428; 68/12.01

(57) ABSTRACT

Various appliance models are made by installing a control console onto a base unit. The base units of the appliances are all identical, with the control consoles having different control features, so that different appliance models are made by the different consoles installed on the standardized base units. The console is selected by a purchaser and is mounted by the dealer or retailer or by the manufacturer at a regional warehouse. The appliance can be easily upgraded by removing the first selected console and exchanging for a second selected console having additional control features.

### BACKGROUND OF THE INVENTION

Appliances, such as washers and dryers, conventionally consist of a base unit housing the various electrical components for performing the functions of the appliance, and a control console housing the controls necessary to control operation of the components in the base unit. For example, the washer base unit includes a cabinet housing a motor, a rotatable tub, pumps, an agitator or washing mechanism, and other devices needed to get the clothes wet, washed with or without detergent, rinsed, and then spun to extract moisture. Similarly, a base unit for a dryer contains the blower, motor, heating devices, thermostats, and a rotating drum for containing the clothes.

Each different model of a particular line of appliances typically requires the manufacturer to assemble a complete appliance, with both the base unit and the console. The appliance dealer or retail establishment thus must have an inventory of different models. Maintaining an inventory of all the models is costly due to the models themselves and the storage space required. If a customer desires a model which is not available at the dealer's site, the entire appliance must be shipped from the manufacturer to the dealer for delivery to the customer. Shipping of unavailable models delays delivery to the customer, and may add to the cost if shipping is expedited.

Therefore, it is desirable to reduce the inventory needs of a dealer or retail establishment, and minimize shipping costs and time.

Accordingly, a primary objective of the present invention is the provision of appliances having a standard base unit and interchangeable control consoles.

Another objective of the present invention is the provision of a method of assembling appliances wherein different models are created using identical base units and different control consoles.

A further objective of the present invention is the provision of a method of assembling an appliance wherein a purchaser selects the control console to be mounted on a standardized base unit to provide an appliance with desired functional features for the purchaser.

Another objective of the present invention is the provision of an appliance which can be upgraded by changing the control console on the base unit of the appliance.

These and other objectives become apparent from the following description of the invention.

### SUMMARY OF THE INVENTION

An appliance, such as a clothes washer or dryer, dishwasher or range, is provided with a standardized base unit having the same operative components as other similar appliances. A control console for the base unit is selected from a group of consoles each having different control features, such that each different control console creates a different model appliance with different functional features.

The method of assembling an appliance includes the step of providing a base unit, allowing a purchaser to select a control console from a plurality of control consoles each having different control features for operating components in the base unit, and then mounting the selected control console onto the base unit to create the assembled appliance. The appliance can be upgraded by removing the selected control console and mounting a second selected control console having additional control features. The console is mounted downstream of the manufacturing facility, later in the distribution process. It may be mounted at a regional warehouse, retail establishment or by an appliance dealer. Thus, a plurality of different appliance models can be created with a single standardized base unit with interchangeable control units.

### BRIEF DESCRIPTION OF THE DRAWINGS

FIG. 1 is a perspective view of an assembled appliance according to the present invention.

FIG. 2 is a perspective schematic showing a standardized base unit with different control consoles which can be selectively mounted on the base unit to create different appliance models, according to the present invention.

### DETAILED DESCRIPTION OF THE DRAWINGS

An appliance, such as a clothes washer or dryer, dishwasher or range, is designated in the drawings by the reference numeral 10. The appliance includes base unit 12 and a control console 14.

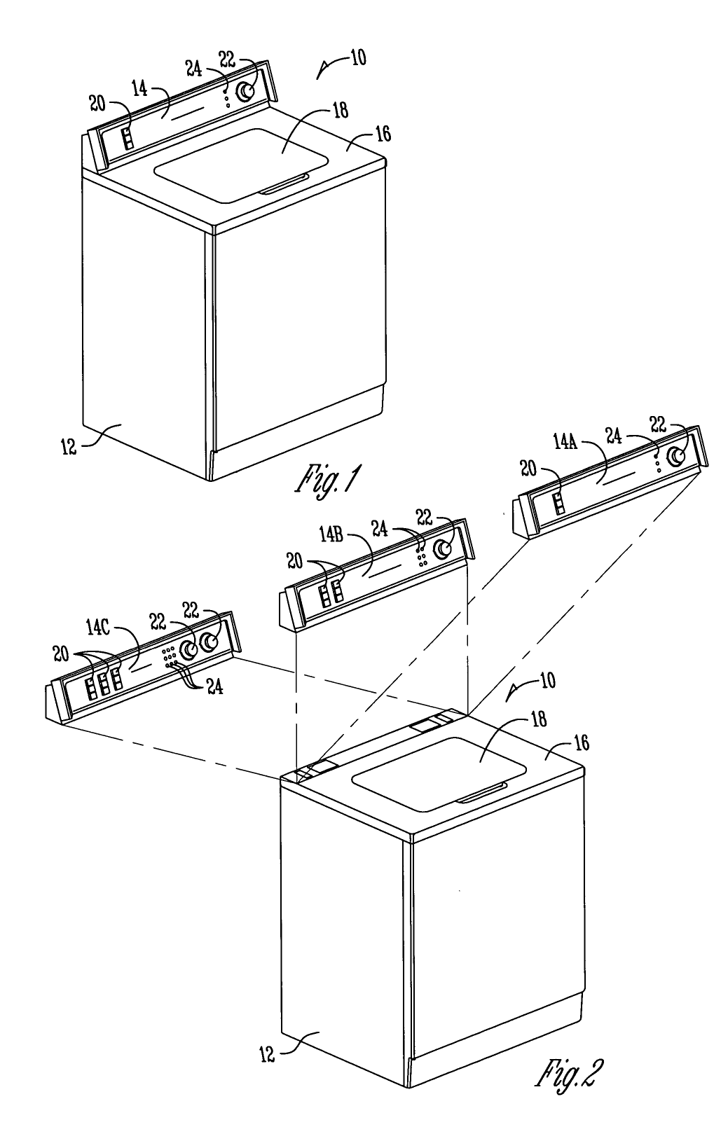

The base unit 12 includes a cabinet with a top cover 16 and a door 18 which house the various components which perform the washing or drying function of the appliance. The appliance 10 may be a top loading appliance, with the door 18 on the top cover 16, as shown in FIG. 1, or may be a front loading appliance with the door 18 mounted on the front panel (not shown). During the manufacturing process, every washer or dryer will have a standardized identical base unit 12 with the same internal functional components.

The control console 14 includes various buttons 20 and dials 22 for controlling the operation of the components in the base unit 12. The buttons 20 and dials 22 may be electromechanical or electronic. Lights 24 may also be provided on the console 14 to indicate particular cycles or functions of the appliance 10.

In the manufacturing stage, different consoles 14A, 14B, and 14C are made, each having different control features. For example, console 14A is for a low end model with minimal features, console 14B is for an average model, and console 14C is for a high end model with many features. It is understood that the manufacturer may have as many different consoles 14 as desired. The three consoles 14A, B, C shown in FIG. 2 are merely representative of the options available. While the various consoles 14A, B, C can be assembled onto the standardized base units 12 at the manufacturing plant, the assembly can also be delayed until a purchase is made by a consumer. In such case, the base units 12 and consoles 14A, B, C are shipped separate from one another to a regional warehouse, a dealer or retail establishment.

A consumer can then select the console 14A, 14B or 14C, depending upon the desired functions. The selected console 14A, B, C is then installed on the base unit 12. Installation may be performed by the manufacturer at the warehouse. Alternatively, it could be installed at a retail establishment or by a dealer's representative in the consumer's home. If the customer later wishes to upgrade the appliance 10, the originally selected console 14A, B, C is removed and a different console 14 with additional features can be installed.

In the above-described example, it should be understood that the fully assembled appliance 10 created by assembling console 14A or 14B may contain components within base unit 12 that are not utilized. In other words, some electrical components of base unit 12 may not be electrically connected to the control console 14A or 14B. In practice, the increased average cost of base unit 12 must be offset by savings in inventory carrying cost, increased sales due to improved product availability and improved dealer relations.

Thus, each console 14A, B, C creates a different model appliance 10. The differentiation between models based strictly upon the selected consoles allows customers to select from a wider variety of appliance models. At the same time, the dealer or retail establishment or regional warehouse can stock less base units in inventory, and keep sufficient quantities of the various consoles 14A, B, C to assemble the various appliance models. Alternatively, the dealer or retailer can utilize express or overnight delivery of consoles 14, rather than delivery of a complete, assembled appliance 10. Therefore, the dealer or retailer does not have to stock every model of the appliance 10. Furthermore, service of inoperable appliances 10 is simplified, since the technician can quickly diagnose the problem as being in either the base unit 12 or the console 14.

While the invention has been described with respect to a clothes washer or dryer, it should be understood that it could be applied, but not limited, to additional usage with ranges and dishwashers.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

1. A method of assembling appliances, comprising:
providing a plurality of base units with identical components;
providing a plurality of control consoles with different control features;
selecting a first control console from the plurality of consoles; and
mounting the first control console onto one of the base units to create a first model of the appliance wherein the base unit of the first model include electrical components that are not electrically connected to the first control console.

2. The method of claim 1 further comprising selecting a second control console from the plurality of consoles with control features different from the first control console; and mounting the second control console on a second of the base units to create a second model of the appliance.

3. The method of claim 2 wherein all electrical components of the base unit are electrically connected to the second control console.

4. The method of claim 1 wherein the console selection is made by a consumer.

5. The method of claim 1 wherein the console mounting is done at a retail establishment.

6. The method of claim 1 wherein the console mounting is done by an appliance dealer.

7. The method of claim 1 wherein the console mounting is done at a regional warehouse.

8. A method of assembling an appliance, comprising:
allowing a purchaser to select a control console from a plurality of consoles each having different control features for operating components in a base unit; and
then mounting the selected control console onto the base unit to create the assembled appliance.

9. The method of claim 8 wherein the mounting is done at a retail establishment.

10. The method of claim 8 wherein the mounting is done at the purchaser's home.

11. The method of claim 8 wherein the mounting is done by a dealer representative.

12. The method of claim 8 further comprising upgrading the appliance by removing the selected control console and mounting a second selected control console having additional control features.

13. The method of claim 8 wherein the console mounting is done at a regional warehouse.

14. An appliance, comprising:
a base unit;
electrical components in the base unit for performing functions of the appliance;
a control console mounted on the base unit and being electrically connected to less than all of the electrical components to control the components; and
the control console being selected from a group of consoles each having different control features.
